(19) United States
(12) Patent Application Publication
(10) Pub. No.: US 2013/0032688 A1
(43) Pub. Date: Feb. 7, 2013

(54) EQUIPMENT SUPPORT PAD

(71) Applicants: Darryl L. Snyder, Canton, OH (US); Bryan Dougherty, Delroy, OH (US); Paul E. Dougherty, Canton, OH (US)

(72) Inventors: Darryl L. Snyder, Canton, OH (US); Bryan Dougherty, Delroy, OH (US); Paul E. Dougherty, Canton, OH (US)

(21) Appl. No.: 13/567,954

(22) Filed: Aug. 6, 2012

Related U.S. Application Data
(60) Provisional application No. 61/515,321, filed on Aug. 4, 2011.

(51) Int. Cl. F16M 9/00

(52) U.S. Cl. 248/637

(57) ABSTRACT

An equipment support pad includes a plastic body formed from upper and lower walls joined together by sidewalls and a plurality of angled support elements. The same support elements may be arranged to form different-size support pads. The support elements are arranged with a plurality of oval-shaped elements disposed generally parallel to one another and with two triangle-shaped elements at the lateral corners and two diamond-shaped elements are the other two corners. A variety of different pieces of equipment may be supported on these pads. In exemplary configurations, the equipment support pads are used to support heating, ventilation, and air conditioning equipment.

### CROSS REFERENCE TO RELATED APPLICATIONS

This application claims the benefit of U.S. Provisional Patent Application Ser. No. 61/515,321 filed Aug. 4, 2011; the disclosures of this application are incorporated herein by reference.

### BACKGROUND

1. Technical Field

The disclosure relates to plastic pads that may be used under equipment such as air conditioner condensers, heat pump units, or swimming pool equipment. The pads also may be filled with a material and used as sidewalk or garden steps.

2. Background Information

Different pieces of equipment are installed on support pads that function as a base for the equipment especially when the equipment is used outside on the ground. One example is an air conditioner condenser for a central air conditioning system. Another example is swimming pool water pumping and treatment equipment. Building codes generally require an air conditioner compressor to be placed on a support pad that elevates the condenser above the ground, keeps it level, and limits the moisture and dirt that contacts the bottom of the condenser. The pad also helps maintain air flow to the bottom of the condenser by limiting vegetation growth around the bottom of the condenser. Outdoor heat pump equipment is also mounted on a ground support pad.

In the past, most such equipment was mounted on concrete pads that were either poured in place or pre-formed and placed at the needed location. Drawbacks with the concrete pads include the high weight for transport and installation and the risk of cracking. Other air conditioner pads have been made from plastic and other materials but have drawbacks such as that they require multiple components to be connected, include upper recesses or through holes that collect water, do not provide adequate support without fillers or solid sections, narrow feet or rims that sink into soft ground, are heavy, or require separate ground anchors to remain stable.

SUMMARY OF THE DISCLOSURE The disclosure provides a plurality of equipment support pad configurations with each configuration including a plurality of the same support elements arranged in similar relations to one another. A variety of different pieces of equipment may be supported on these pads. In exemplary configurations, the equipment support pads may be used to support heating, ventilation, and air conditioning equipment; pool equipment; and outdoor heat pump units.

The disclosure provides an equipment support pad having a generally uninterrupted upper surface that receives the equipment. The upper surface is free of through-holes that allow water to access the interior or underside of the pad. The upper surface also may be free of recesses that gather pools of water.

The equipment support pad is made from plastic, is generally hollow, and is light weight for easy transport and placement. Despite these characteristics, the support pad is provided with a plurality of supports that make the pad strong enough to support heavy equipment is a stable and secure manner.

The equipment support pad has a lower surface broken by a plurality of recesses that face the ground surface when the equipment support pad is placed on the ground. These recesses may be used to anchor the equipment support pad to the ground by increasing the friction between the pad and the ground while not allowing the pad to sink into soft ground or become tilted. The combined size of the recesses is limited.

The upper surface of the support pad may be smooth or textured (not smooth to a person's touch) to provide friction between the item being supported and the pad.

The supports of the pad, which are defined by walls that extend between the upper and lower walls of the pad, are disposed at the corner areas of the equipment support pad and in the central areas. Each support has an angled sidewall. The tops of the supports may be connected to the upper wall of the pad. The supports are arranged into parallel spaced strengthening ribs that include at least two central supports.

Although not needed when functioning as an equipment support pad, the disclosure provides an equipment support pad having a secondary use. The pad may be provided with a hatch that allows the pad to be filled with a material to provide ballast and support such that the pad may be walked on. In this condition, the pad may be used as a stepping stone or a sidewalk pad.

The support pad may be provided in a variety of different sizes and shapes and colors.

The disclosure provides a support pad that may be blow molded from plastic which may include or consist of recycled plastic.

The disclosure provides a support pad that may be stacked for shipping and storage. In such configurations, the equipment support pad may be provided with stacking fingers and corresponding recesses so that stacked pads interlock.

The disclosure also provides lifting feet that are used to lift the equipment off of the top of an equipment support pad.

The different configurations may be used alone or in combination.

### BRIEF DESCRIPTION OF THE DRAWINGS

FIG. 1 is a bottom plan view of an exemplary configuration of an equipment support pad.

FIG. 2 is an end view of the equipment support pad of FIG. 1.

FIG. 3 is a section view taken along line 3-3 of FIG. 1.

FIG. 4 is a perspective view of the bottom of the equipment support pad of FIG. 1 showing optional stacking fingers disposed at the corners of the pad.

FIG. 5 is a perspective view of the top of the equipment support pad of FIG. 1 showing optional recesses disposed at the corners to receive the optional stacking fingers.

FIG. 6 is a bottom plan view of the equipment support pad of FIG. 5.

FIG. 7 is a top plan view of the equipment support pas of FIG. 5.

FIG. 8 is an end view of the equipment support pad of FIG. 5.

FIG. 9 is a perspective view of the bottom of an alternative configuration of the equipment support pad.

FIG. 10 is a perspective view of the bottom of an alternative configuration of the equipment support pad.

FIG. 11 is a perspective view of the bottom of an alternative configuration of the equipment support pad.

FIG. 12 is a perspective view of the bottom of an alternative configuration of the equipment support pad.

FIG. 13 is a perspective view of the bottom of an alternative configuration of the equipment support pad.

FIG. 14 is a side view of a first configuration of a foot used to lift equipment up off the ground or above the upper surface of an equipment support pad.

FIG. 15 is a section view taken along line 15-15 of FIG. 14.

FIG. 16 is a side view of a second taller configuration of a foot used to lift equipment up off the ground or above the upper surface of an equipment support pad.

FIG. 17 is a section view taken along line 17-17 of FIG. 16.

FIG. 18 is a side view of a base used with the feet depicted in FIGS. 14-17.

FIG. 19 is a bottom plan view of the base of FIG. 18.

FIG. 20 is a top plan view of the base of FIG. 18.

FIG. 21 is a section view taken along line 21-21 of FIG. 20.

Similar numbers refer to similar parts throughout the specification.

### DETAILED DESCRIPTION OF THE DISCLOSURE

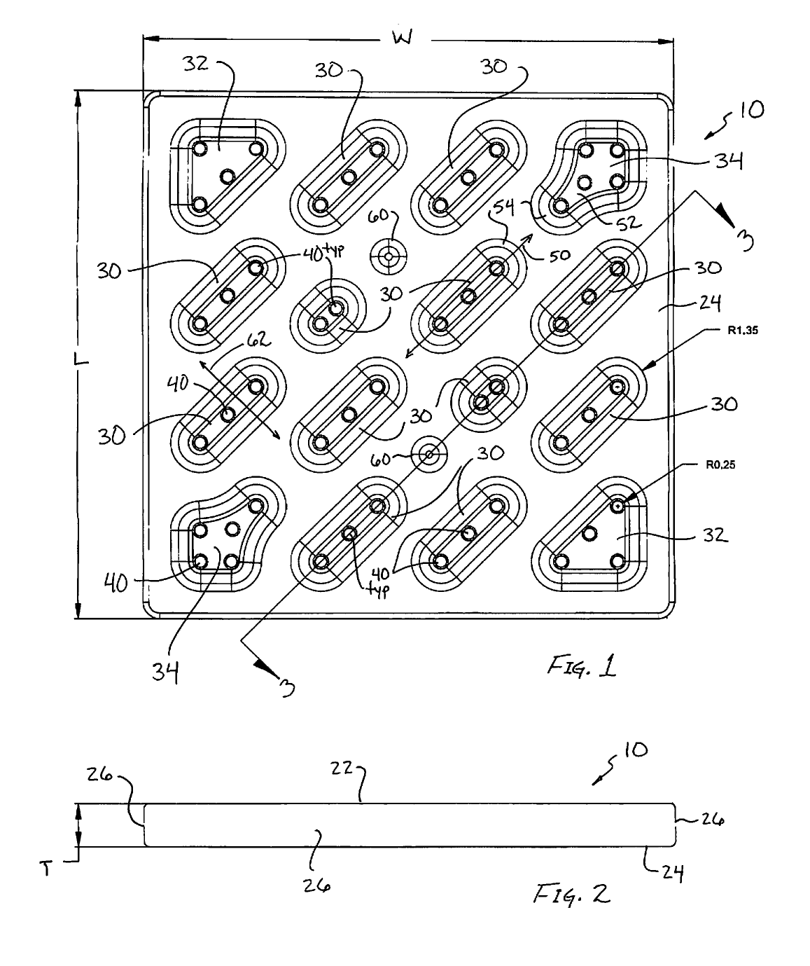

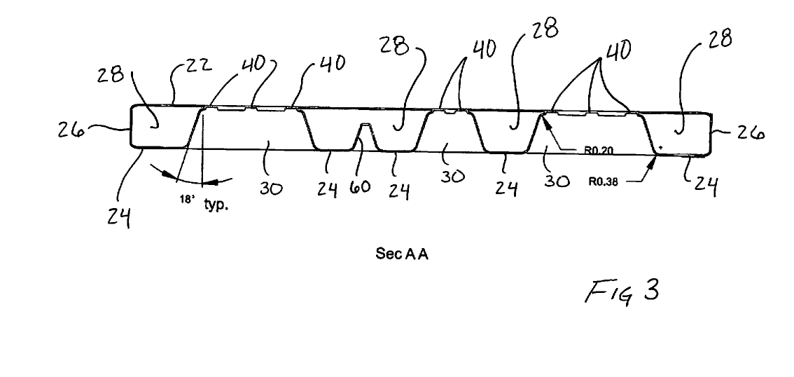

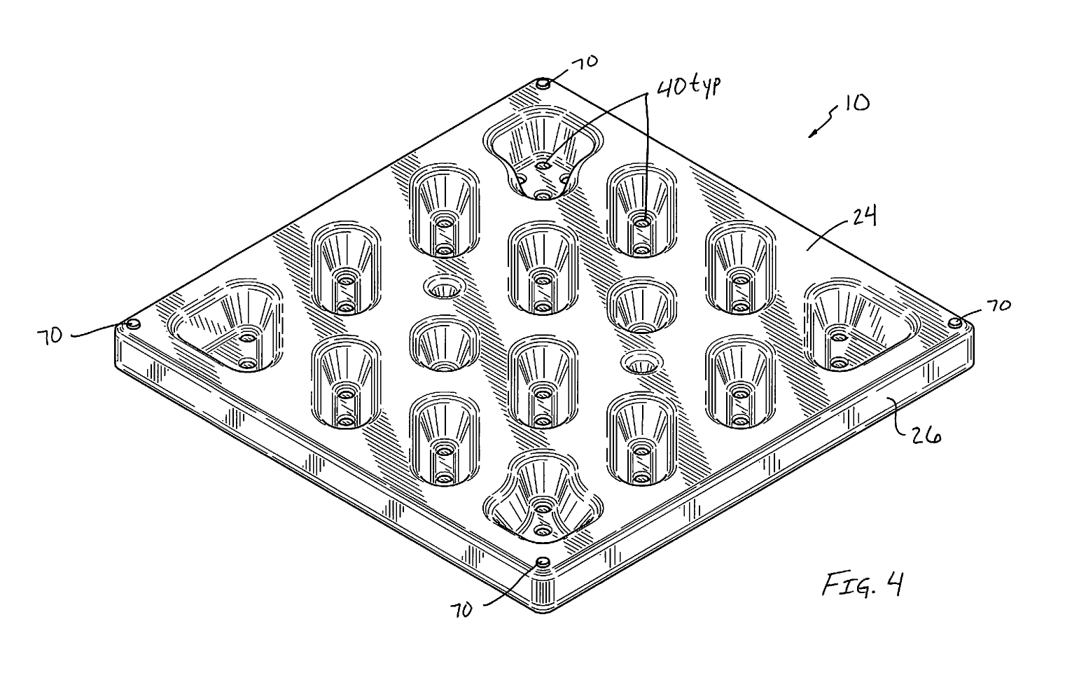

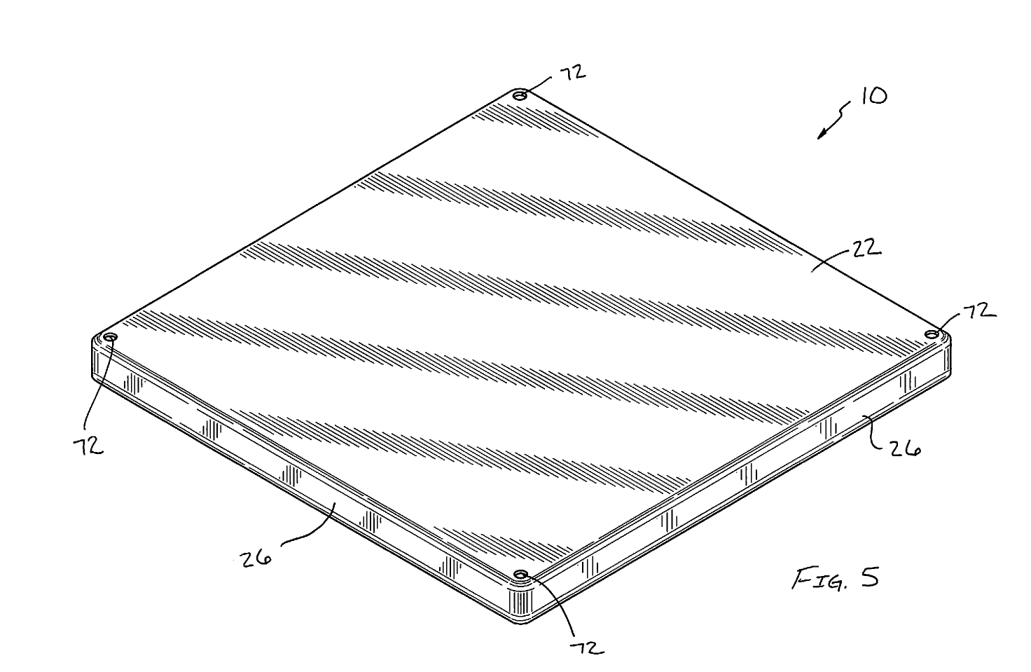

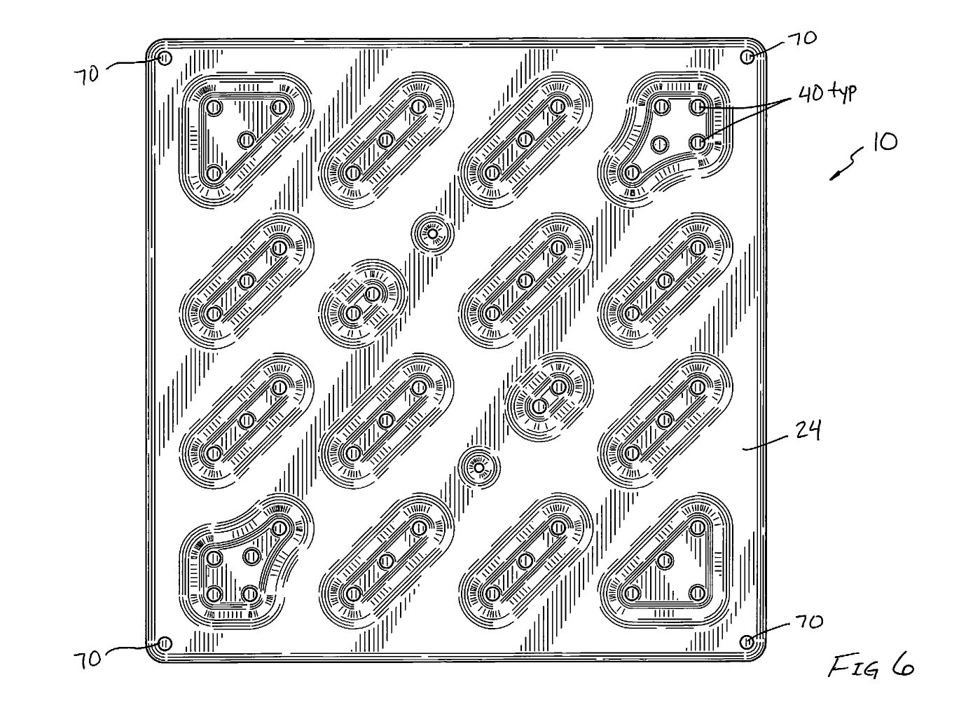

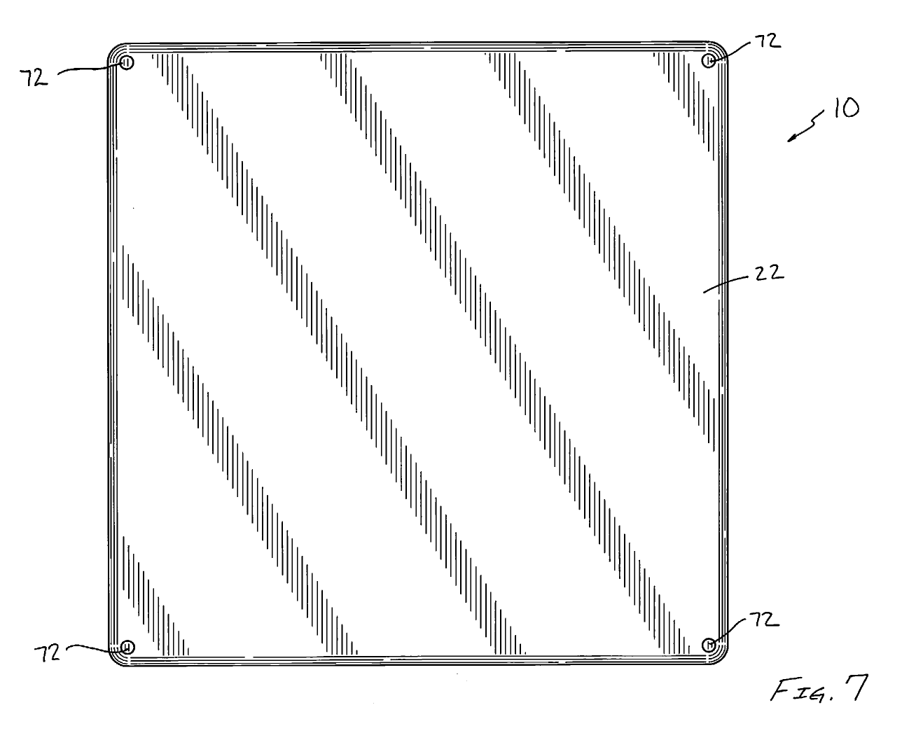

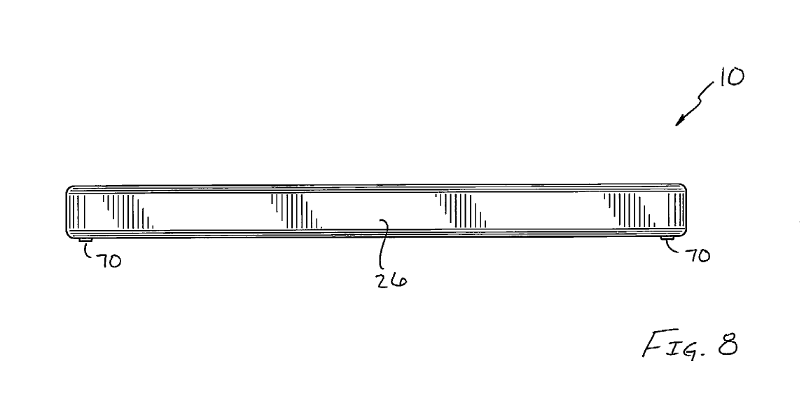

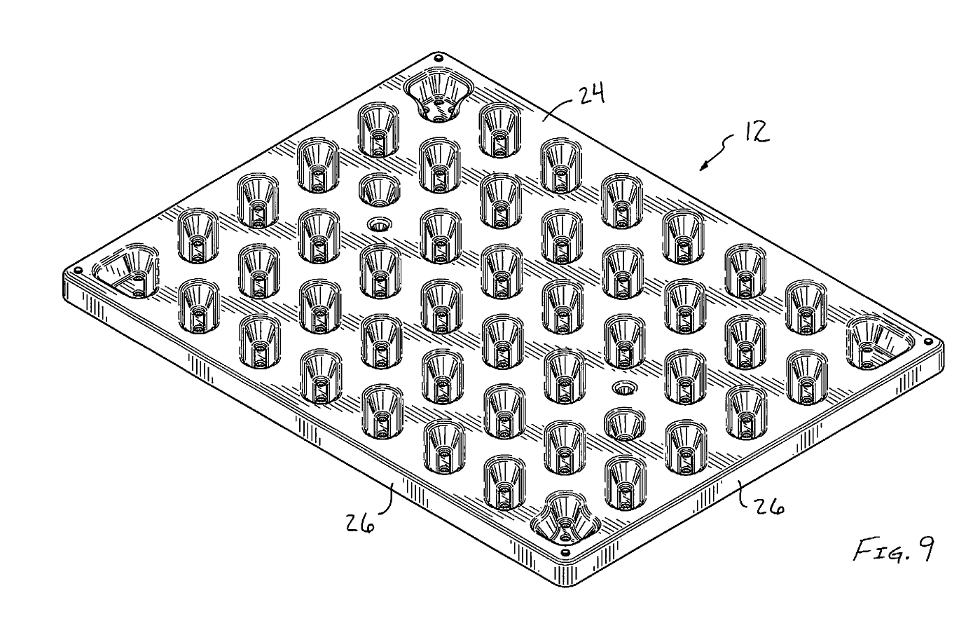

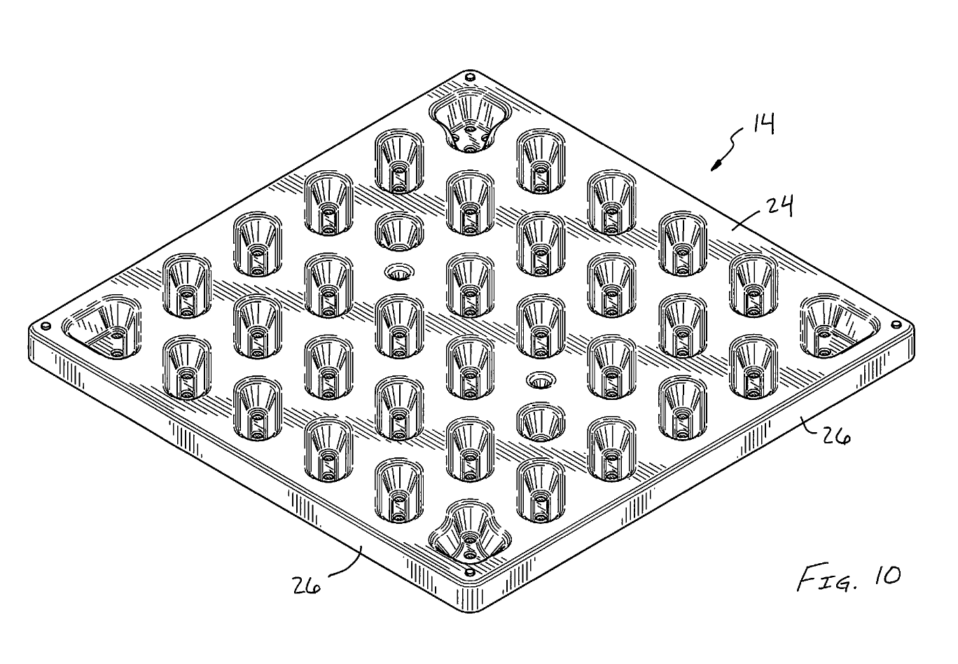

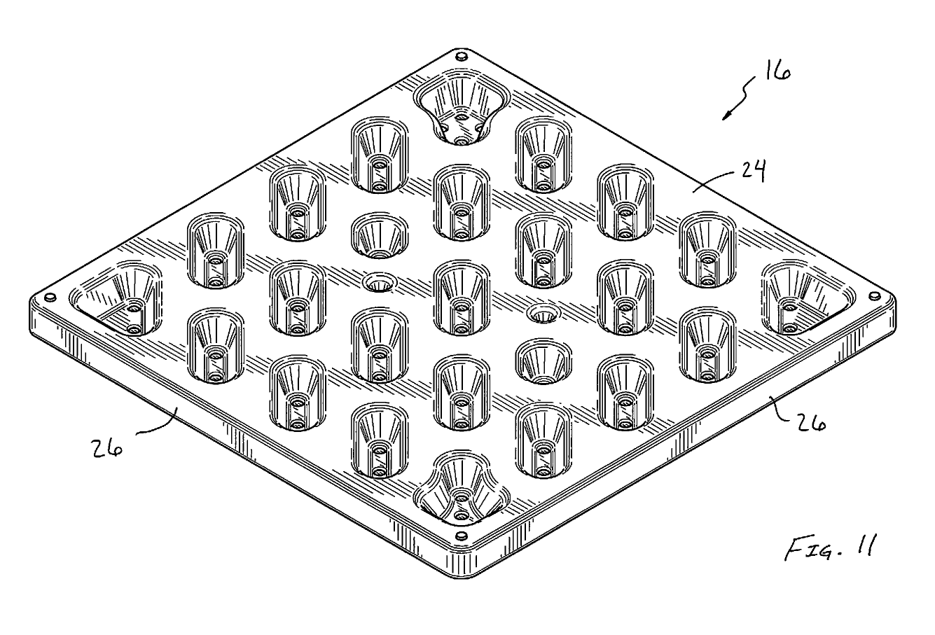

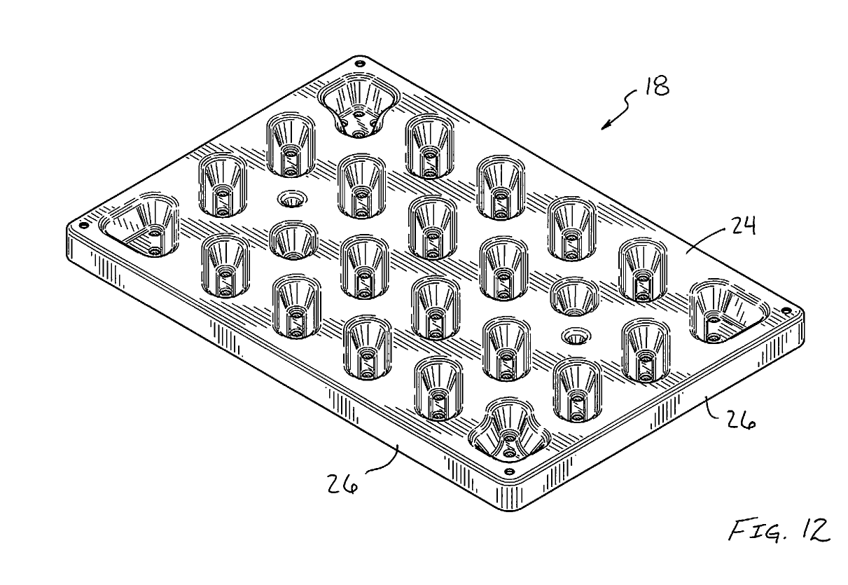

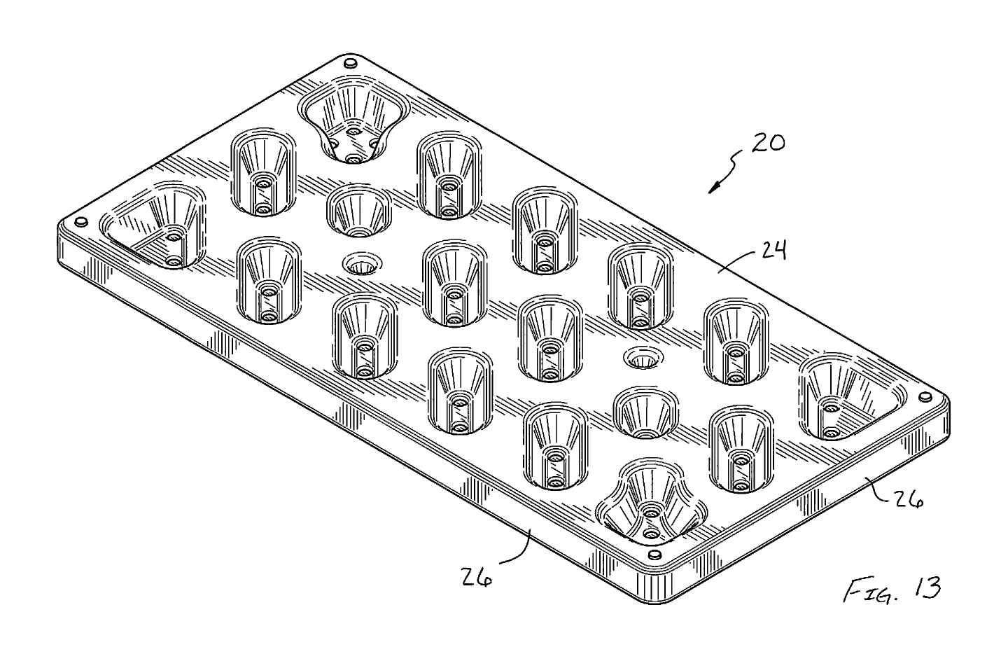

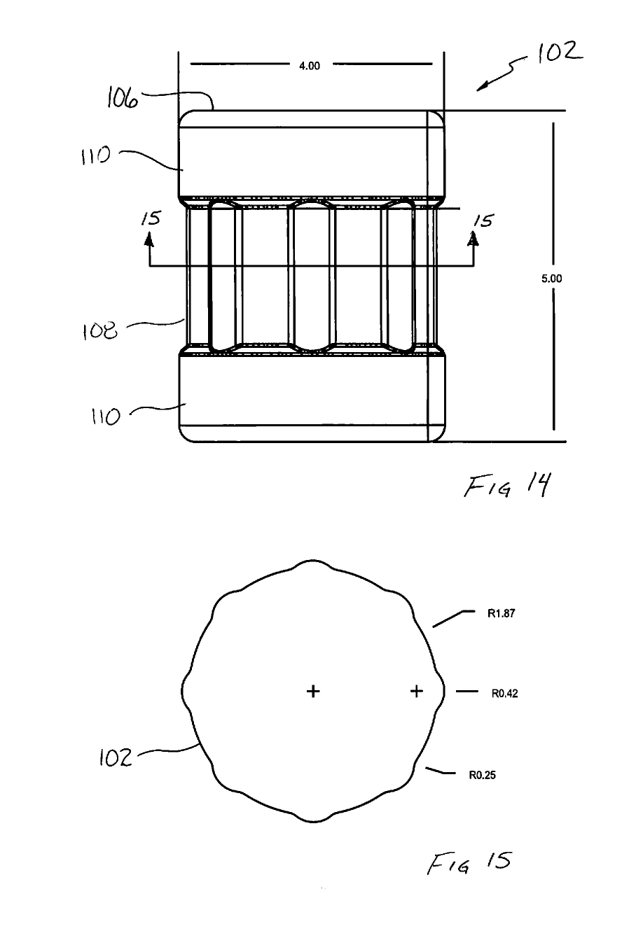

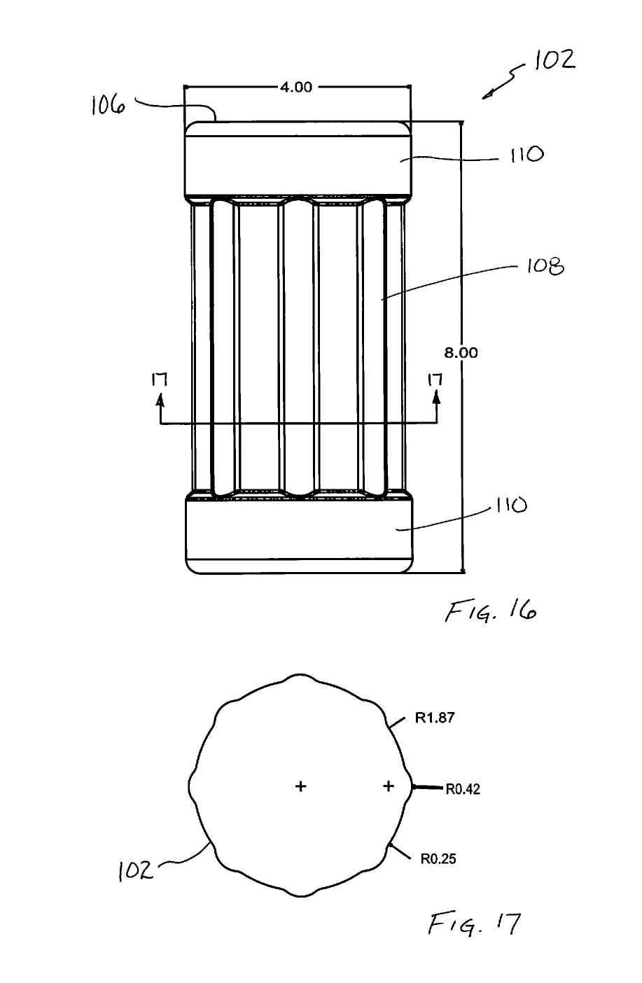

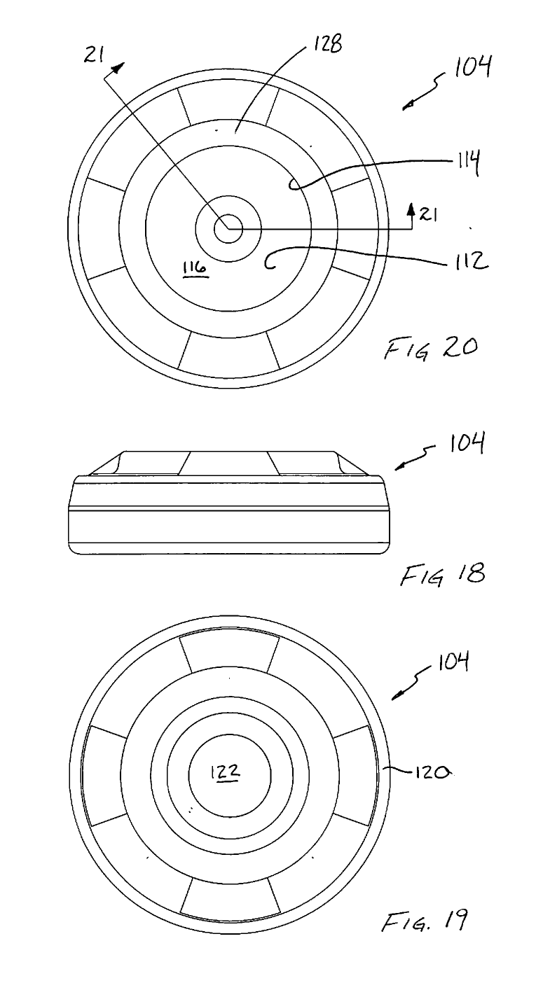

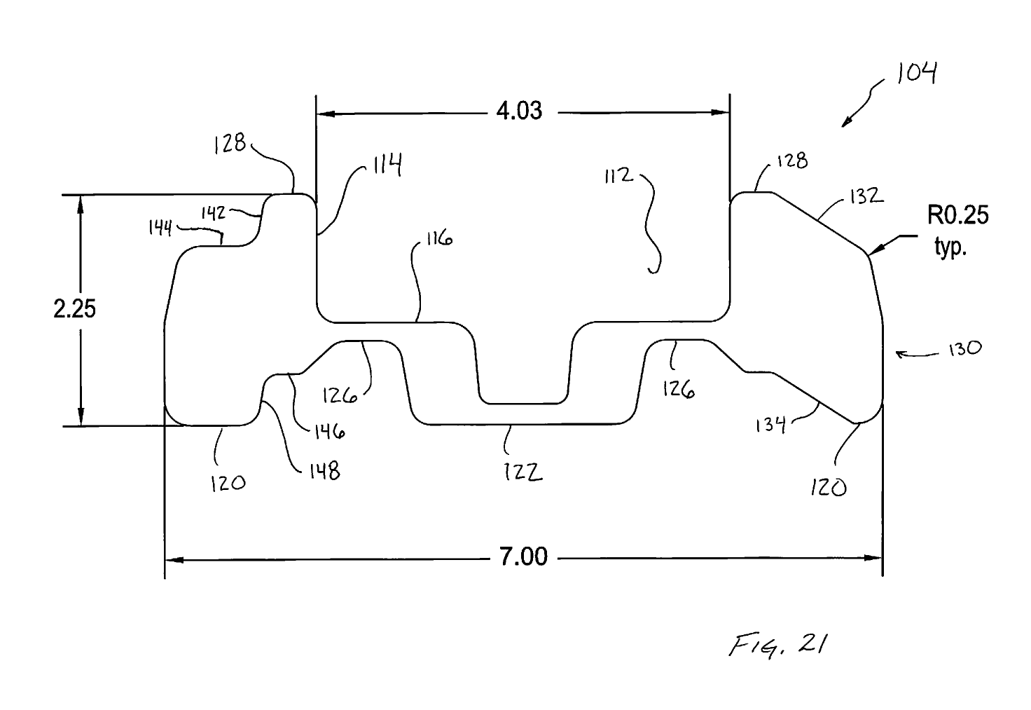

A first configuration of an exemplary support pad is indicated generally by the reference numeral 10 in FIGS. 1-8. Pad 10 of FIGS. 1-8 is generally square and is two foot wide ‘W’ by two foot long 1′ and two or three inches thick ‘T’ (see FIG. 2). Other sizes may be formed using the same basic building blocks of supports as shown in FIGS. 9-13 wherein FIG. 9 depicts a three foot by four foot rectangular pad 12, FIG. 10 depicts a three foot by three foot square pad 14, FIG. 11 depicts a two-and-a-half foot by two-and-a-half foot square pad 16, FIG. 12 depicts a two foot by three foot rectangular pad 18, and FIG. 13 depicts a three foot by a foot-and-a-half rectangular pad 20. Other configurations may be four by four foot, five by five foot, or round with a variety of diameters. Other thicknesses may be provided.

Each of the configurations generally includes an upper wall 22, a lower wall 24, and a sidewall 26 that are joined (or integrally formed) to define a hollow interior chamber 28. Sidewall 26 may be configured to join the outer perimeters of walls 22 and 24 so that there is no overhang or lip on pad 10. The corners between sidewall 26 and upper wall 22 may be rounded at a 0.25 inch radius; the corners between sidewall 26 and lower wall 24 may be rounded at a 0.25 inch radius; and the sidewall corners (between width and length dimensions) may be rounded at a 0.75 inch radius. A variety of plastics may be used but a polyethylene has been found to be useful for blow molding pad 10 and walls 22, 24, and 26 may be formed to a thickness of 0.06 to 0.120 inches in one exemplary configuration with wall thicknesses of 0.030 to 0.130 inches being possible. Equipment support pad 10 is manufactured from plastic that may include or consist or recycled plastic materials. In one configuration, equipment support pad 10 is made from polyethylene and is colored similar to the color of cured cement. Benefits of using plastic for the pads include the ability to color the pad to blend in with different environments, the ability of the plastic pad to resist moisture penetration and damage in wet environments, and the ability to form the plastic into strong but light weight configurations.

With reference to the first configuration, FIGS. 1, 3, 4, and 6 depict the plurality of central supports 30 and the two types of corner supports 32 and 34 that are disposed between the upper wall 22 and the lower wall 24 of equipment support pad 10. The configuration and arrangement of supports 30, 32, and 34 allow equipment support pad 10 to receive and support relatively heavy equipment such as an air conditioner condenser unit in a stable and secure manner in a wide variety of weather conditions. Corner supports 32 and 34 are disposed at the corners of the square and rectangular pad configurations which is where many pieces of equipment that are to be supported on pads 10 have feet located. Each support 30, 32 and 34 has a plurality of tacks 40 where the material of support 30, 32 and 34 is integrally joined (such as by melting or welding during the molding process) to the material of the upper wall 22 to strengthen pad 10. Tacks 40 may be formed without interrupting the smooth upper surface of upper wall 22. Corner supports 32 and 34 may include four tacks 40 while central supports 30 may include two or three tacks 40.

Each support 30, 32, and 34 has a flat top wall that is connected to upper wall 22 with tacks 40 and an angled sidewall (disposed at an 18 degree angle from vertical as shown in FIG. 3) such that each support 30, 32, and 34 is generally in the shape of a frustum with the upper portion being smaller than the lower portion. The angled sidewalls are integrally formed with lower wall 24 and define openings in lower wall 24 at the location of each support.

Central supports 30 are disposed evenly throughout the area of equipment support pad 10 and are arranged to be parallel to one another. In this configuration, each central support 30 has rounded ends with a rectangular central portion. The length of central supports varies as needed but all of central supports 30 are disposed parallel to one another. The parallel direction of each support 30 is indicated by reference line 50 in FIG. 1 and is the direction parallel to a reference line running through both centers of its rounded portions which is also the longitudinal direction of support 30 and the direction of the parallel walls of it central portion. Arranging central supports 30 aligned and parallel to one another creates strengthening ribs of aligned supports 30 such as the one shown in section in FIG. 3. Each of these strengthening ribs includes at least two aligned central supports 30. No strengthening rib is continuous from sidewall 26 to sidewall 26 in any configuration and every strengthening rib is spaced from sidewall 26. In the exemplary rectangular configurations, the longitudinal direction of central supports 30 is disposed at a forty-five degree angle to the sidewalls 26 such that one of the strengthening ribs is aligned with each corner support 34. Corner supports 34 include a neck portion 52 that forms a part of the strengthening rib by being aligned with central supports 30 and having the same shape end wall 54 as central supports 30. Corner supports 34 that form portions of the strengthening ribs are thus different from the triangularly-shaped corner supports 32 that are not aligned with central supports 30. Corner supports 34 may be described as being shaped like arrowheads of diamonds. Each pad 10 is thus supported by a plurality of parallel strengthening ribs that define the hollow chamber 28 through which air must flow during a blow molding process. The air injection points 60 are aligned with strengthening ribs but are not tacked off (see FIG. 3). Using parallel ribs provides for good air flow. Supports 30 are also arranged to overlap in a direction perpendicular to the longitudinal direction of supports 30 such that a reference line (such as line 62 in FIG. 1) cannot be located from sidewall 26 to an opposite sidewall 26 without passing through one of supports 30 when line 62 is located between corner supports 34.

Each support 30, 32, and 34 defines a recess or opening that is open to the bottom of pad 10. These recesses or openings act to grip the ground and accommodate irregular ground surfaces. These recesses or openings can also accommodate changes in ground conditions during changing weather conditions. The amount of open space defined by supports 30, 32, and 36 is less than about 40 percent of the total available surface area. For example, in the two foot by two foot pad 10, the ends of central supports 30 have a 1.35 inch radius at the lower surface with longer central supports 30 having a rectangular central portion that is 3.6 inches long. In this example, the flat area is about 347 square inches which is about 60 percent of the total available surface area. Having the flat portion of lower wall 24 consist of 50-70 percent of the available surface area is desired. In this configuration, the overall weight of pad 10 may be maintained under five pounds.

The upper surface of the upper wall 22 of pad 10 is smooth (or slightly textured for frictional grip) to provide a desirable surface for placing equipment. The upper surface is free of depressions such that there are no recesses into which an equipment foot would not be supported. The lack of recesses prevents water and dirt from gathering. The continuous upper surface prevents water and dirt from having ready access to the underside of pad 10.

In an alternative optional configuration, support pad 10 that may be stacked and interlocked for shipping and storage. In such configurations, the equipment support pad may be provided with stacking fingers 70 and corresponding recesses 72 so that stacked pads 10 interlock. The arrangement of these elements may be reversed as shown in FIG. 12.

The support pad configurations shown herein may be provided with an access hatch (or such a hatch may be cut after they are formed) to allow the generally hollow pads to be filled with ballast such as water, sand, foam, or concrete. When filled with a ballast, the support pads may be used as steps in a sidewalk or stepping “stones” in a pathway such as that used in garden.

FIGS. 14-21 depict the components of foot assemblies that are used to lift equipment or an equipment support pad 10 off of the ground surface or used to lift equipment above the upper surface of equipment support pad 10. Each foot assembly includes a pillar 102 that is removably received in a base 104. Base 104 may be placed on a support surface such as directly on the ground or on the upper surface of equipment support pad 10. Pillar 102 extends up from base 104 to provide a raised generally flat support surface 106 that receives equipment or a support pad 10.

Pillars 102 are not adjustable in length but are provided in a variety of different lengths such as the five inch version depicted in FIG. 14 and the eight inch version depicted in FIG. 16. Other lengths are provided as necessary for different applications.

Each pillar 102 may be hollow. In alternative configurations, each pillar 102 is solid or includes internal supports. Each pillar 102 has an inset fluted sidewall 108 disposed between upper and lower cylindrical ends 110. The fluted sidewall 108 strengthens pillar 102. Ends 110 are configured to be received within a recess 112 defined by a continuous inner sidewall 114 of base 104. The bottom of recess 112 is defined by a lower inner wall 116.

Base 104 provides an outer ground engagement ring 120 and an inner ground engagement ring 122 with both rings 120 and 122 having lower surfaces that are essentially co-planar as shown in FIG. 21. Outer ground support ring 120 has a diameter greater than 1.5 times the diameter of pillar 102 to provide stability and to spread the support force. Providing inner ground support ring 122 ensures support for pillar 102 in the situation when a portion of outer support ring 120 overhangs an edge of equipment support pad 10. Inner ground support ring 122 also provides a direct line of support under pillar 102 in the situation wherein inner lower wall 116 collapses down and engages ring wall 126.

As shown in FIGS. 18-21, each base 104 is made up of eight alternating edge portions with the section view of FIG. 21 depicting one of each edge portions. These edge portions are disposed radially outwardly of inner sidewall 114 and each defines a portion of a common upper ring wall 128. Four edge portions 130 have angled upper walls 132 than slop directly from upper ring wall 128 down to the outer sidewall of base 104. Portions 130 also have angled lower walls 134 disposed parallel to wall 132 sloping upwardly and inwardly from outer support ring 120. The other four edge portions 140 have upper and lower stepped configurations defined by walls 142, 144, 146, and 148.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. An equipment support pad; comprising:
an upper wall;
a lower wall;
a sidewall joining the upper wall and the lower wall of the upper and lower walls;
a plurality of supports extending between the upper and lower walls; each of the supports being spaced from the sidewall; and
each support defining an opening in the lower wall.

2. The equipment support pad of claim 1, wherein each support is defined by an angled wall and a top wall; portions of the top wall being connected to the upper wall.

3. The equipment support pad of claim 2, wherein at least two supports are aligned and parallel to define a strengthening rib.

4. The equipment support pad of claim 3, wherein the at least two aligned supports include walls disposed parallel to one another.

5. The equipment support pad of claim 4, further comprising a corner support and the strengthening rib including the corner support.

6. The equipment support pad of claim 1, wherein the supports include central supports and corner supports; the central supports having a longitudinal dimension and being arranged parallel to their longitudinal dimensions and overlapped in the perpendicular direction.

7. The equipment support pad of claim 1, wherein the walls and supports are formed from plastic.

8. The equipment support pad of claim 1, wherein each support defines an opening in the lower wall; the combined surface are of the openings is less than 50 percent of the total available surface area of the lower wall.

9. The equipment support pad of claim 1, wherein each support defines an opening in the lower wall; the combined surface are of the openings is less than 40 percent of the total available surface area of the lower wall.

10. The equipment support pad of claim 1, wherein the upper wall is free of through openings.

11. The equipment support pad of claim 10, wherein the upper wall is flat and free of recesses.

12. The equipment support pad of claim 11, wherein the upper wall is textured.

13. The equipment support pad of claim 1, wherein the upper wall is joined to the sidewall at a rounded corner.

14. The equipment support pad of claim 1, wherein the lower wall is joined to the sidewall at a rounded corner.

15. The equipment support pad of claim 1, wherein the supports include central supports and corner supports; the central supports having longitudinal dimensions and all being arranged parallel to their longitudinal dimensions.

16. The equipment support pad of claim 15, wherein the central supports are overlapped in the perpendicular direction.

17. The equipment support pad of claim 15, wherein the central supports are arranged into parallel strengthening ribs with each strengthening rib including at least two aligned central supports.

18. The equipment support pad of claim 17, wherein each central support includes rounded end walls and straight sidewalls.

19. The equipment support pad of claim 18, wherein at least one of the strengthening ribs includes a corner support that itself includes a neck having a rounded end wall in the same shape as the end wall of the central support.

20. The equipment support pad of claim 1, further comprising a plurality of foot assemblies used with the equipment support pad; each of the foot assembles including a pillar that is removably received in a base.
